(19) United States
(12) Patent Application Publication
(10) Pub. No.: US 2020/0353607 A1
(43) Pub. Date: Nov. 12, 2020

(54) Fastener Holding Driver

(71) Applicant: David Charles Levinson, Savannah, GA (US)

(72) Inventor: David Charles Levinson, Savannah, GA (US)

(21) Appl. No.: 16/868,398

(22) Filed: May 6, 2020

Related U.S. Application Data
(60) Provisional application No. 62/874,034, filed on Jul. 15, 2019.
(60) Provisional application No. 62/843,572, filed on May 6, 2019.

(51) Int. Cl. B25B 23/10; B25B 23/12

(52) U.S. Cl. CPC B25B 23/101; B25B 23/12

(57) ABSTRACT

One embodiment of a fastener holding driver with a shank 2 with a tip 1, further having a jaw assembly 27 on the shank 2. The jaw assembly 27 having a jaw 5, lock washers 12 and lock washer springs 14. The fastener holding driver can hold a fastener rigidly to the tip 1.

### CROSS REFERENCE TO RELATED APPLICATIONS

This application claims the benefit of provisional patent application Ser. No. 62/843,572 filed 2019 May 6 by the present inventor.

This application also claims the benefit of provisional patent application Ser. No. 62/874,034 filed 2019 July by the present inventor.

### TECHNICAL FIELD

This application relates to threaded fastener drivers such as screw drivers, ratchets, screw-bits for screw guns or drills or any other fastener driver and more particularly to mechanisms for retaining a fastener onto the tip of the driver.

### BACKGROUND PRIOR ART

U.S. Patents

| Patent Number | Kind Code | Issue Date | Patentee |
|---|---|---|---|
| 2,620,000 | B1 | 1952 Dec. 2 | Noffsinger |
| 2,633,169 | B1 | 1953 Mar. 31 | Siems |
| 2,796,100 | B1 | 1957 Jun. 18 | Dierker |
| 2,960,131 | B1 | 1960 Nov. 15 | Clark |
| 3,604,488 | B1 | 1971 Sep. 14 | Wishart et al |
| 3,710,835 | B1 | 1973 Jan. 16 | Eby |
| 6,997,086 | B1 | 2006 Feb. 14 | Graham |

Foreign Patents

| Foreign Document | Country | | | App or |
|---|---|---|---|---|
| number | Code | Kind Code | Pub Date | Patentee |
| 2508983 | DE | B2 | 1976 Sep. 9 | Willi |

Threaded fasteners are used in almost every type of product and construction all over the world. They range from Phillips head wood screws to hex head machine threaded fasteners and everything in between. There are also a multitude of drivers used to insert them including but not limited to screwdrivers, screw guns with interchangeable bits, ratchet drivers etc.

One of the chief problems of using such drivers is that of keeping the fastener firmly engaged with the tip while the fastener is being driven into a work-piece. Oftentimes the user will only have one hand available to drive the fastener and thus cannot hold the fastener onto the tip. Other times the user will end up dropping and/or losing the fastener. In the case where the fastener is being inserted into a thread with a tight fit or if the fastener is being started into hard material without an existing hole, the user will be required to use a large amount of force. Many times this would result in the fastener slipping out of engagement with the tip of the driver, dropping the fastener, potentially damaging the fastener and/or work-piece and even possibly injuring the user.

Many solutions have been tried to overcome this problem. Magnetized driver tips only hold bits with small force and can easily fall off. Sleeves that fit over the shank of the driver can allow the fastener to fall out and do not hold the fastener rigidly to the tip making accurate placement of the fastener difficult.

U.S. Pat. No. 3,710,835 (Eby) tried to solve the problem by having spring loaded jaws on a spring loaded carriage which held the fastener to the tip. The fact that only the force of the springs retains the fastener onto the tip means that the fastener could come free under even moderate force. Also there is no means to help the user guide the fastener onto the tip of the fastener making it hard to get the screw into position in the first place.

U.S. Pat. No. 6,997,086 (Graham) Uses jaws closed onto the fastener by a screw mechanism where a further screw mechanism holds the fastener against the tip. In this design the operator requires both hands to utilize the screw mechanisms which also take a lot of time and effort to screw and unscrew. There is also no means of helping the user to guide the screw onto the tip.

U.S. Pat. No. 2,960,131 (Clark) Use a one piece sheet metal retaining jaws with plates that grip the shank due to the elasticity of the metal. Because the plates and jaws are all of one piece the force which the plates grip the shaft must necessarily be smaller or else the user will not easily be able to position the jaws. In addition there is no stop on the front shank to keep the jaws/plates from being pushed off the shank altogether. There is also no way to have the jaws automatically pulled back onto the fastener and also be pulled back from the tip without the user having do manually do it, nor is there a means to help the user guide the screw onto the tip.

U.S. Pat. No. 2,633,169 (Siems) Has a fixed jaw that is held by the force of a set screw in the jaw assembly against the shank. This is a very cumbersome arrangement that requires both hands and a lot of time to operate and also the use of a separate set screw wrench which the user might not have.

U.S. Pat. No. 2,620,000 (Noffingser) Has a barrel with fixed jaw held against the fastener by lock washers biased against the shank by a lock washer spring. A sliding plug when pushed on by the user acts to tilt the washers out of engagement and the barrel with the fixed jaw to be pushed forward releasing the fastener. This has many drawbacks, the first of which is there is no stop to keep the barrel from being pushed off the shank by the user. There is no means to help the user guide the fastener onto the tip of the driver nor a spring to automatically push the fastener into engagement with the tip while also providing a means to automatically retract the assembly out of the way when using just the tip of the driver without the fastener being held onto the jaws. Also because there is only one lock washer spring and no structure in the barrel to position it properly, the force that lock washers grip the shank with is limited.

Additionally because the outer diameter of the cylindrical barrel (14) of Noffsinger is held constant through the length of the part the section holding the lock washers (24) must be kept smaller. This causes the opening (27) in the wall of the barrel to have an insufficient distance from the shank (10). This results in the opening (27) exerting less tilting force on the lock washers (24) when the barrel is pushed towards the screw resulting in inadequate force holding the screw onto the bit (12). If the barrel (14) were to be enlarged to overcome this problem than the section of the barrel (14) holding the screw onto the tip would be very large relative to the screw. This would make it very difficult to get the screw into narrow spaces as well as making it difficult to insert the screw into the barrel (14).

Foreign Patent DE 2,508,983 (Willi) Uses a fixed Jaw in a barrel that is held onto the fastener with the force of a spring. As mentioned before this is clearly inadequate if a even a small amount of force is used inserting the fastener.

### SUMMARY

This section provides a general summary of the disclosure and is not a comprehensive disclosure of its full scope or all of its features.

In accordance with one embodiment a fastener holding driver having shank with a tip for driving a fastener. The fastener being held rigidly onto the tip by a jaw assembly with a jaw, lock washers, lock washer springs and a jaw assembly spring for biasing the jaw assembly in a direction on the shank. Also having a stop to limit the motion of the jaw assembly towards the tip of the shank as well as a structure on the jaw assembly to help guide the head of the fastener onto the tip. Further having structures on the jaw assembly to locate the lock washer springs as well as a magnetized tip. Further having the ability to telescope the front jaw carriage section to expose more of the tip.

### Advantages

Accordingly several advantages of one or more aspects are as follows: To provide a fastener holding driver that will hold a fastener to the tip of the driver, that can be operated with one hand, that has a stop to prevent the assembly from coming off the end of the driver, that has a means to help the user to guide the fastener onto the tip of the driver, that retracts the jaw back from the tip of the driver so that the driver can be used in a normal fashion when the fastener holding feature is not being used and that can retain the fastener onto the tip with a large amount of force. The fastener holding driver can telescope to expose more of the shank for tight spaces and has a surface for releasing the lock washers on the tip side of the lock washers which aids in ergonomics. In addition the fastener holding driver does not allow the lock washers to rotate about the shank which would affect their gripping strength with power tool applications. A surface to release the lock washers is also provided towards the jaw so that the user can release the lock washers with the same hand inserting the screw, useful in the case where the users other hand is far away as in the case of a power tool attachment. Other Advantages of one or more aspects will be apparent from a consideration of the drawings and ensuing description.

### DRAWINGS (FIGS. 1-18)—FIGURES 1^{st} EMBODIMENT

FIG. 1 shows an 3D exploded view of the fastener holding driver.

FIG. 2 shows a partial 3D assembly with the lock washers 12, lock washer springs 14, jaw assembly spring 19, jaw assembly grommet 20 and jaw assembly retaining clip 21 installed.

FIG. 3 shows a 3D completed jaw assembly 27 with the shank 2 partially installed.

FIG. 4 shows a 3D completed fastener retaining driver assembly.

FIG. 5 shows a 3D view of the jaw carriage lower half 8.

FIG. 6 shows a 3D view of the jaw carriage upper half 9.

FIG. 7 shows a 3D view of the assembled jaw carriage 10.

FIG. 8 shows a 3D view of the push ring 22.

FIG. 9 shows a closeup 3D view of jaw 5 pushed forward and a fastener 28 inserted into the jaw slot 6.

FIG. 10 shows a closeup 3D view of jaw 5 holding a fastener 28 against the driver tip 1.

FIGS. 11-18 show sectional views of the 1^{st}embodiment fastener retaining driver in operation.

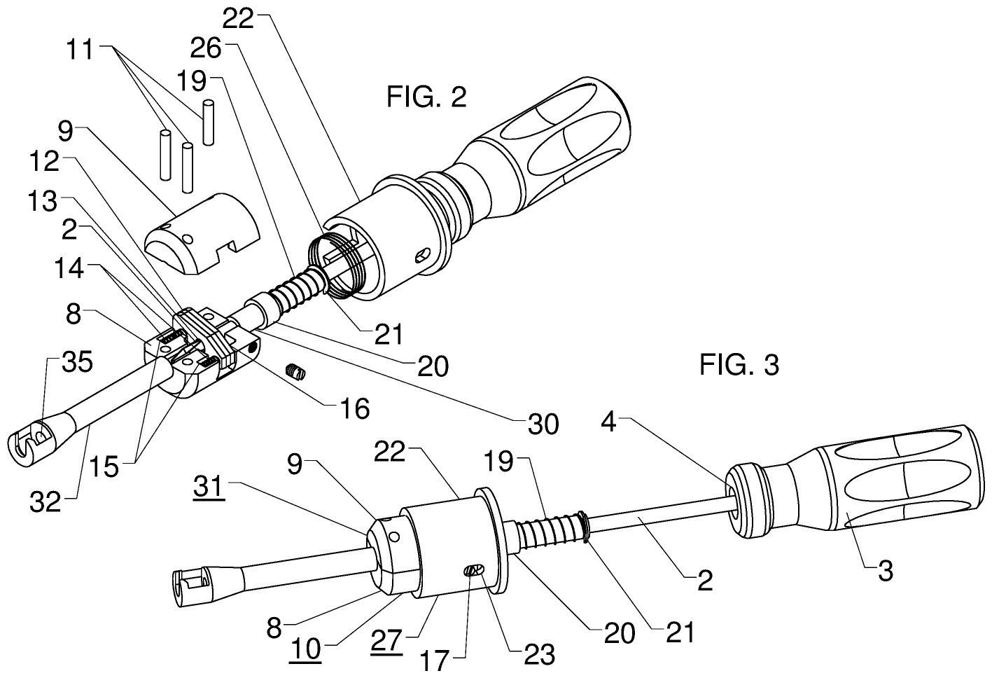

### DRAWINGS (FIGS. 19-35)—FIGURES 2^{nd} EMBODIMENT

FIG. 19 shows an 3D exploded view of the fastener holding driver.

FIG. 20 shows a 3D view of a partial assembly with the lock washers 12-2, lock washer spring 14-2 and front jaw carriage section 32-2 installed.

FIG. 21 shows a 3D view of a partial assembly with the jaw carriage 10-2 assembled.

FIG. 22 shows a 3D view of a partial assembly with the push ring 22-2 assembled over the jaw carriage 10-2.

FIG. 23 shows the completed 3D view of the jaw assembly 27-2.

FIG. 24 shows the 3D view completed fastener driver

FIGS. 25-26 show the 3D view of operations of telescoping the front jaw carriage section 32-2 with the push ring upper half 42-2 removed for visibility.

FIGS. 27-28 show the 2 d view of operations of telescoping the front jaw carriage section 32-2

FIG. 29 highlights the 3 d view Jaw carriage shank flat engagement surfaces 37-2 and the shank flat surfaces 37-2

FIGS. 30-35 show the 2 d view of the 2^{nd} embodiment fastener retaining driver in operation.

### DRAWINGS—REFERENCE NUMERALS 1^{st} EMBODIMENT

1) Tip

2) Shank

3) Handle

4) Handle hole

5) Jaw

6) Jaw slot

7) Jaw fastener guide surface

8) Jaw carriage lower half

9) Jaw carriage upper half

10) Jaw carriage

11) Jaw carriage pins

12) Lock washers

13) Lock washer Holes

14) Lock washer springs

15) Lock washer spring cavities

16) Lock washer fulcrum

17) Push ring retaining set screw

18) Push ring retaining set screw hole

19) Jaw assembly spring

20) Jaw assembly grommet

21) Jaw assembly retaining clip

22) Push ring

23) Push ring retaining set screw slot

24) Push ring lock washer slot

25) Push ring clearance hole

26) Push ring spring

27) Jaw assembly

28) Fastener

29) Work-piece

30) Rear jaw carriage section

31) Middle jaw carriage section

32) Front jaw carriage section

33) Lock washer cavity

34) Jaw assembly retaining clip groove

35) Jaw carriage hole

### DRAWINGS—REFERENCE NUMERALS 2^{nd} EMBODIMENT

1-2) Tip

2-2) Shank

3-2) Handle

4-2) Handle hole

5-2) Jaw

6-2) Jaw slot

8-2) Rear jaw carriage lower half

9-2) Rear jaw carriage upper half

10-2) Jaw carriage

11-2) Jaw carriage pins

12-2) Lock washers

13-2) Lock washer holes

14-2) Lock washer spring

16-2) Lock washer fulcrum

19-2) Jaw assembly spring

20-2) Jaw assembly Grommet

21-2) Jaw assembly retaining clip

22-2) Push ring

24-2) Push ring lock washer slot

27-2) Jaw assembly

28-2) Fastener

29-2) Work-piece

31-2) Rear jaw carriage section

32-2) Front jaw carriage section

33-2) Lock washer cavity

34-2) Jaw assembly retaining clip groove

35-2) Jaw assembly hole

36-2) Jaw carriage shank flat engagement surface

37-2) Shank flat surfaces

38-2) Push ring Forward engagement surface

39-2) Front jaw carriage section positioning screw

40-2) Front Jaw carriage section positioning slot

41-2) Push ring lower half

42-2) Push ring upper half

44-2) Push ring rear section

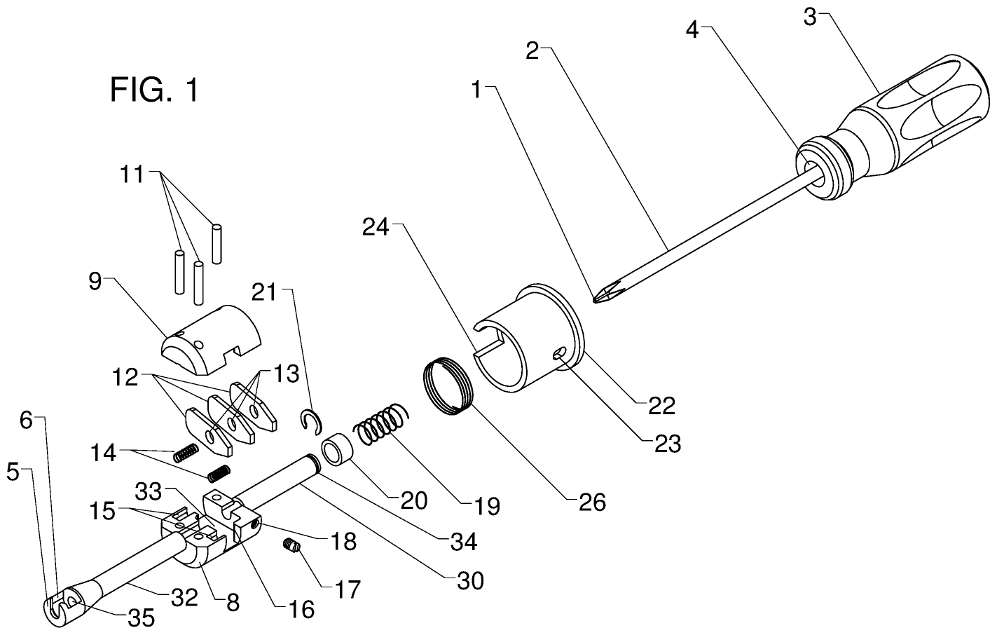

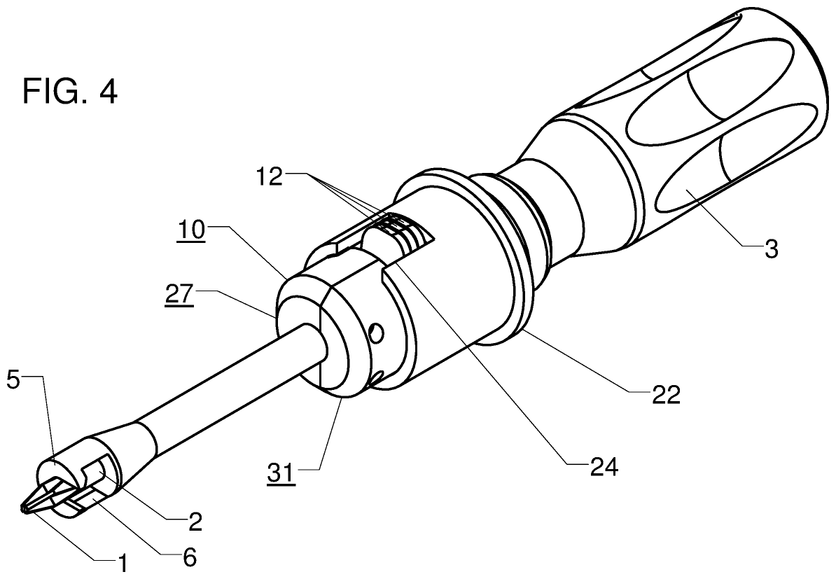

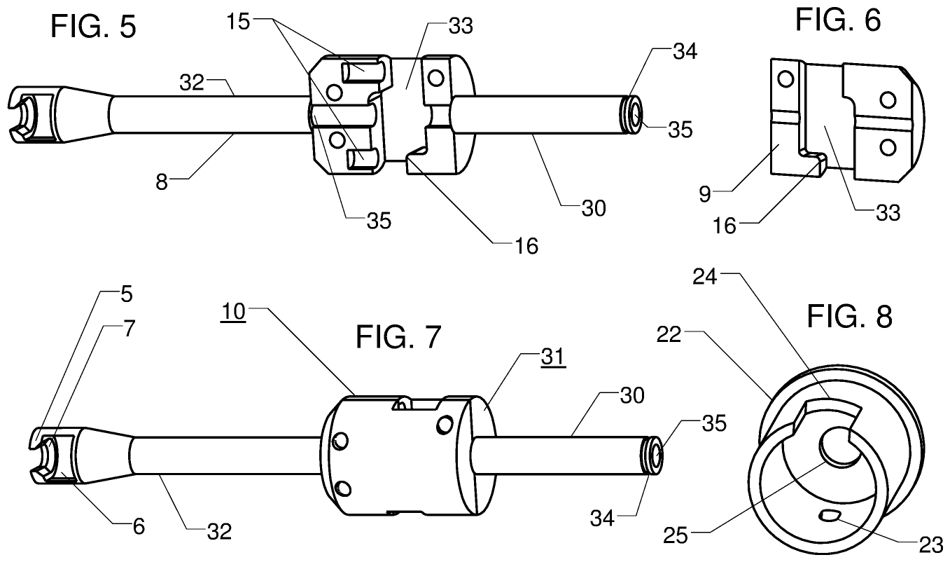

### DETAILED DESCRIPTION—FIGS. 1 TO 18—FIRST EMBODIMENT

### Detailed Description—Shank 2, Tip 1, Handle 3 and Handle Hole 4.

In one embodiment of the fastener holding driver consists of a shank 2 with a tip 1. The tip 1 is magnetized to help temporarily hold a fastener. The other end of the shank 2 is inserted into a handle 3 with a handle hole 4 which is a cylindrical cavity with its axis centered with axis of the shank 2 on the side of the handle 3 facing the tip 1 shown in FIG. 1.

In this instance the tip is one used for driving a Phillips head type fastener but any type of tip can be used (Slotted, Torx, Hex socket, etc.). Also instead of having a handle the fastener holding driver could just have a shank which could be inserted as a bit into a drill, screw-gun, or handle for interchangeable bits or have the shank be part of any other device used to drive fasteners such as a ratchet wrench. It should also be noted that other surfaces of the fastener holding driver could be magnetized instead of the tip to help to temporarily hold the fastener in place.

### Detailed Description—Jaw Carriage 10, Jaw 5, Jaw Slot 6 and Jaw Fastener Guide Surface 7.

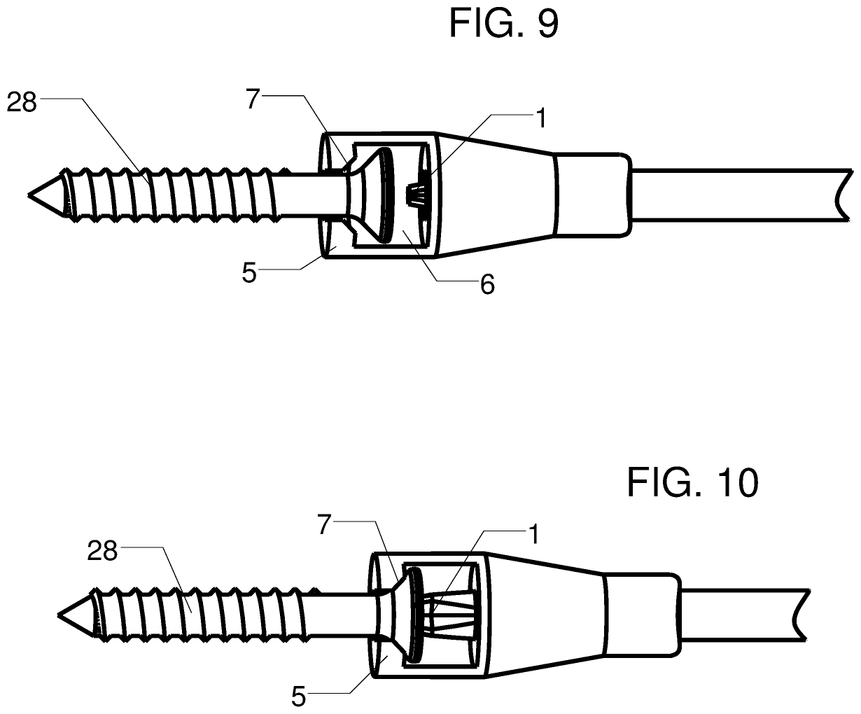

In this embodiment there is a jaw carriage 10 consisting of a jaw carriage lower half 8 and a jaw carriage upper half 9 which are assembled with jaw carriage pins 11 (FIG. 2 and FIGS. 5-7). The jaw carriage 10 has a cylindrical (barrel) rear jaw carriage section 30 on the end of which is a jaw assembly retaining clip groove 34. In the middle of the jaw carriage 10 there is a middle jaw carriage section 31 which is a larger cylindrical body and contains a lock washer cavity 33, lock washer spring cavities 15, and a lock washer fulcrum 16. On the other side of the middle jaw carriage section 31 from the rear jaw carriage section 30 is the front jaw carriage section 32 which is a cylindrical barrel. A jaw carriage hole 35 for the shank 2 runs through all three sections of the jaw carriage 10. The front jaw carriage section 32 has a jaw 5 and jaw slot 6 in the end of the barrel opposite the rear jaw carriage section 30. The jaw slot 6 is a cylindrical space with the same axis as that of the jaw carriage hole 35 and is slightly larger in diameter than the jaw carriage hole 35. The jaw slot 6 also has an opening in one side of the barrel of the front jaw carriage section 32 (FIGS. 2,5,7). The jaw 5 consists of the bottom structure and surface of the cylindrical section of the jaw slot 6 which is facing the rear jaw carriage section 30 and also has a slot opening in the same direction as that of the opening for the jaw slot 6. Additionally the jaw 5 has a jaw fastener guide surface 7 which is a concave surface formed in the jaw 5 surface facing towards the rear jaw carriage section 30 (FIGS. 9-10). The jaw fastener guide surface 7 helps guide a fastener into engagement with the tip 1 and provides a means and structure to help the user to guide a fastener onto the tip 1. The outside diameter of the front jaw carriage section 32 with the jaw 5 and jaw slot 6 is kept as small as possible to allow the driver to insert screws in confined spaces and to facilitate the insertion of the screw into the jaw slot 6.

In this embodiment there is only one fixed jaw however there could be more than one jaw and the jaws could be fixed or moving with the screw inserted directly into the one or more jaws on the same axis as the shaft. The jaw carriage could also be just one piece or any other combination of equivalent parts. Additionally the fastener guide surface could consist of structures on either the jaw and or tip or both or other independent structures to help guide the fastener into engagement with the tip. The fastener guide surface could also have a much larger concave surface so that fasteners that have heads where the underside is flat also can be seated by contact with the surface.

### Detailed Description—Lock Washers 12, Lock Washer Springs 14 and Lock Washer Spring Cavities 15.

Shown in FIGS. 1-3, three lock washers 12 are placed into the lock washer cavity 33 with the tops of the lock washers 12 sticking out of the jaw carriage 10 which allows the user to manipulate the lock washers 12. The tops of a lock washer 12 is defined by the portion of the lock washer 12 on the other side of the shank 2 from the lock washer fulcrum 16. Lock washer springs 14 are placed into lock washer spring cavities 15 located above and below the jaw carriage hole 35. The jaw carriage upper half 9 is then assembled to the jaw carriage lower half 8 with the jaw carriage pins 11 forming a complete jaw carriage 10. The lock washer spring cavities 15 provide structures on the jaw assembly 27 to locate the lock washer springs 14.

In this embodiment more than one lock washer spring is used which helps give extra gripping force. The lock washer spring cavities also provide a structure on the jaw assembly to locate the lock washer springs which also helps generate more force. However, it should also be noted that any number of lock washers and lock washer springs could be used in a variety of configurations in conjunction with one or more lock washer spring cavities which would provide structures and means for locating the lock washer springs. Alternately no structure for the lock washer springs could be used as well. It should also be noted that having the tops of the lock washers project out of the jaw carriage allows the user to manipulate the lock washers either with an additional element as in this embodiment or alternately by having no element and the user pushing on the tops of the lock washer directly. Additionally not all of the lock washers have to project out of the jaw carriage for this to occur, one or more of the tops of the lock washers could project from the jaw carriage and still allow the user to manipulate all of them.

### Detailed Description13 Jaw Assembly 27, Push Ring 22, Push Ring Spring 26, Jaw Assembly Grommet 20, Jaw Assembly Spring 19 and Jaw Assembly Retaining Clip 21.

After the jaw carriage 10 is assembled, the push ring spring 26 is then placed over the rear jaw carriage section 30 up against the larger diameter of the middle jaw carriage section 31. A push ring 22 is then placed with a push ring clearance hole 25 over the rear jaw carriage section 30 and then over both push ring spring 26 and part of the middle jaw carriage section 31 so that the force of the push ring spring 26 tends to push the push ring 22 away from the lock washers 12. The push ring 22 acts as an element to manipulate the lock washers 12. The push ring spring 26 normally keeps the push ring 22 away from the lock washers 12 when force on the push ring 22 is relaxed, preventing the push ring 22 from interfering with the lock washers 12 being fully tilted by the lock washer fulcrum 16 and lock washer springs 14 and allowing the lock washers 12 to grip the shank 2 with full strength. In this instance the push ring spring 26 comprises an element and means to normally keep the push ring 22 from contacting the lock washers 12. A push ring retaining set screw 17 is then placed through a push ring retaining set screw slot 23 in the push ring 22 and into the push ring retaining set screw hole 18 located on the middle jaw carriage section 31. This retains the push ring 22 against the middle jaw carriage section 31 and allows the push ring 22 limited movement along the axis of the jaw carriage hole 35 (FIGS. 1-3). A push ring lock washer slot 24 allows the push ring 22 to fit around the lock washers 12 without normally contacting them. However if a force is placed on the push ring 22 towards the jaw 5 and against the push ring spring 26 then the back of the push ring lock washer slot 24 will contact the lock washers 12 (FIGS. 1-4, 8).

After the push ring 22 is installed a jaw assembly grommet 20 and then a jaw assembly spring 19 are placed over the rear jaw carriage section 30 and then a jaw assembly retaining clip 21 is placed into the jaw assembly retaining clip groove 34 (FIGS. 2-3).

Collectively the jaw carriage 10, lock washers 12, lock washer springs 14, push ring 22, push ring spring 26, push ring retaining set screw 17, jaw assembly spring 19 and jaw assembly retaining clip 21 are referred to as the jaw assembly 27 in this embodiment (FIG. 3). Further the jaw fastener guide surface 7 provides a means and structure on the jaw assembly 27 to help the user to guide a fastener onto the tip 1.

The body of the jaw carriage 10 and the push ring 22 have a larger diameter than the front jaw carriage section 32 of the jaw assembly 27 that extends to the jaw 5. The body of the jaw carriage 10 and the push ring 22 have a larger diameter than the jaw 5. When the jaw 5 and the front jaw carriage section 32 of the jaw assembly 27 are smaller than the middle jaw carriage section 31, a user is able to drive a fastener into structures in which a typical fastener driving device would not fit. For example, the smaller jaw 5 and jaw assembly 27 would be insertable into a hole that is only incrementally larger than the fastener itself. Further, the fastener holding driver is easier to manipulate with the smaller jaw 5. The smaller jaw 5 and jaw assembly 27 also make the fastener holding driver lighter and easier to use with a single hand.

It should be noted that section of the jaw carriage 10 containing the lock washers 12 has a larger outside diameter than the front jaw carriage section 32 having the jaw 5 and jaw slot 6. This allows the lock washer fulcrum 16 to be far enough from the centerline of the shank 2 that sufficient tilting force (torque) is put on the lock washers 12. This causes the lock washers 12 to grip the shank 2 with adequate force to keep a screw firmly attached to the tip 1. This size difference also allows the front jaw carriage section 32 having the jaw 5 and jaw slot 6 to be small enough to fit into confined spaces to insert a screw. Thus having the lock washer fulcrum 16 farther away from the centerline of the shank 2 than the end outside diameter of the front jaw carriage section 32 containing the jaw 5 and jaw slot 6 allows the lock washers 12 to grip the shank 2 with sufficient force while also keeping the end of the front jaw carriage section 32 containing the jaw 5 and jaw slot 6 small enough to fit into confined spaces.

### Detailed Description—Final Assembly, Lock Washer Fulcrum 16, Lock Washer Holes 13.

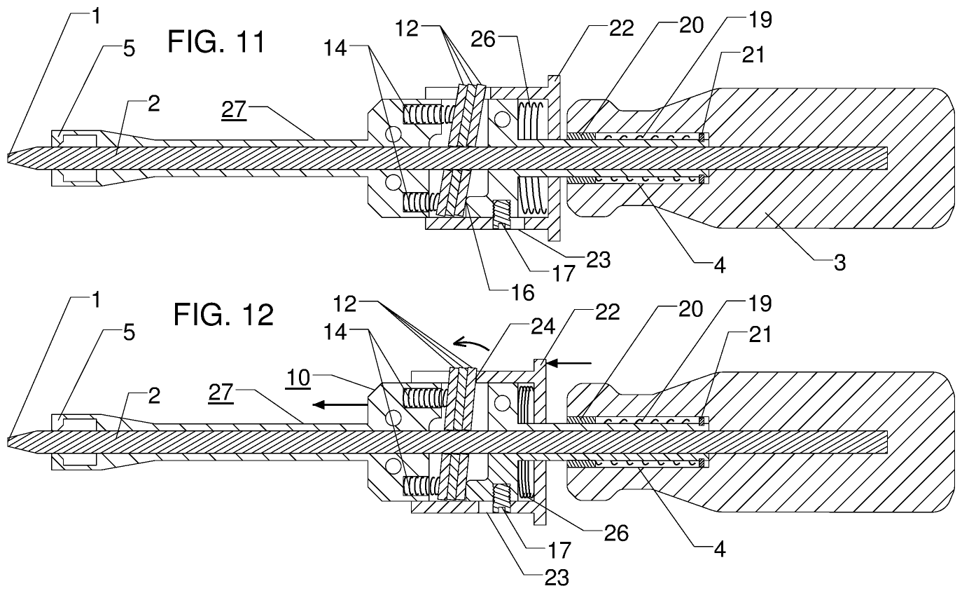

The shank 2 is inserted through the jaw carriage hole 35 at the rear jaw carriage section 30 then through lock washer holes 13 which are holes in the three lock washers 12 that are slightly larger in diameter than the shank 2. The shank 2 is inserted further through the forward jaw carriage section 30 and out through the jaw 5. (FIGS. 1-3). The jaw assembly grommet 20 is affixed to the entrance handle hole 4 so that the part of the rear jaw carriage section 30 with the jaw assembly spring 19 and jaw assembly retaining clip 21 is confined inside the handle hole 4. The force of the jaw assembly spring 19 against the jaw assembly grommet 20 and the jaw assembly retaining clip 21 cause the jaw assembly 27 to be normally pushed back towards the handle 3 until the jaw assembly 27 contacts the bottom of the handle hole 4 retracting the jaw assembly 27 away from the tip 1 so that the tip 1 is exposed (FIGS. 3, 11). This allows the jaw assembly spring 19 to bias the jaw assembly 27 in a direction on the shank 2.

Also the jaw assembly grommet 20, jaw assembly spring 19 and the jaw assembly retaining clip 21 act collectively as a stop to limit the motion of the jaw assembly 27 towards the tip 1 of the shank 2.

Further the lock washer springs 14 push the lock washers 12 against the lock washer fulcrum 16 which is a structure located below the jaw carriage hole 35. This causes the lock washers 12 to tilt and to grip the shank 2 with the lock washer holes 13. In this situation any force that causes the jaw assembly 27 to move away from the tip 1 causes the tilt of lock washers 12 to lessen and to allow movement in that direction. However any movement of the jaw assembly 27 in the direction towards the tip 1 causes the lock washer fulcrum 16 to contact the lock washers 12 with increased force thus increasing their tendency to tilt and increasing the force of the grip of the lock washers 12 on the shank 2 by the lock washer holes 13 preventing movement in that direction (FIG. 2, 15). Additionally in order to aid the gripping force of the lock washers 12 on the shank 2 the hardness of the material of the lock washers 12 is harder than the material of the shank 2.

It should be noted that alternatively the jaw assembly spring could be used to bias the jaw assembly in the other direction or a jaw assembly spring might not be used at all. Also any other type of structure on the shank or jaw assembly could alternately be used for the purpose of a stop limiting the motion of the jaw assembly towards the tip of the shank. The push ring could also be a different structure or types of structures and could move in a variety of different ways. Additionally a stop to limit the movement of the jaw assembly movement away from the tip, such as in the case of a bit without a handle can also be included. Alternatively the material of the shank and lock washers could also be equal in hardness or the shank material could be harder than that of the lock washers depending on what characteristics are required.

The fastener holding driver includes a mechanical stop to prevent the jaw assembly 27 from being removed completely from the shank 2. In an example, the jaw assembly 27 and the shank 2 are parts of a single assembly that is constructed to be used as a single tool. That is, the jaw assembly 27 in the example is not an attachment to an existing tool.

By preventing the fastener holding driver from being removed from the shank 2, the two pieces of the fastener holding driver remain together and are not potentially lost or misplaced. Further, the mechanical stop will provide an additional benefit in that the stop will allow the jaw 5 to be extended past the tip 1 a preferred distance to insert a fastener. That is, the jaw 5 will extend past the tip 1 a distance that allows a fastener to be inserted into the jaw slot 6, but not so far past the tip 1 that the jaw assembly 27 is in danger of disengaging from the shank 2 or becoming insecure.

Also it should be noted that in this specification holding the jaw rigidly is used interchangeably with holding the jaw with large force. This can also mean holding the jaw against great force.

### Operation—FIGS. 11 to 18—First Embodiment

FIGS. 11 to 18 shows sectional views of the fastener holding driver in operation.

FIG. 11 shows the fastener holding driver with the jaw assembly 27 in the position of being normally retracted away from the tip 1 by the jaw assembly spring 19. The push ring 22 is in the position of being normally pushed away from the lock washers 12 by the push ring spring 26. The lock washers 12 are in the position of being normally pushed against the lock washer fulcrum 16 by the lock washer springs 14, causing the lock washers 12 to grip the shank 2 and to prevent any movement of the jaw assembly 27 towards the tip 1.

In FIG. 12 a force is generated by the user on the push ring 22 towards the tip 1. This results in a force on the jaw assembly 27 towards the tip 1. This force also causes the push ring 22 to move against the push ring spring 26 and to contact the lock washers 12 at the back of the push ring lock washer slot 24 causing the lock washers 12 to tilt forward against the force of the lock washer springs 14. This causes the jaw assembly 27 to move forward towards the tip 1 against the force of the jaw assembly spring 19.

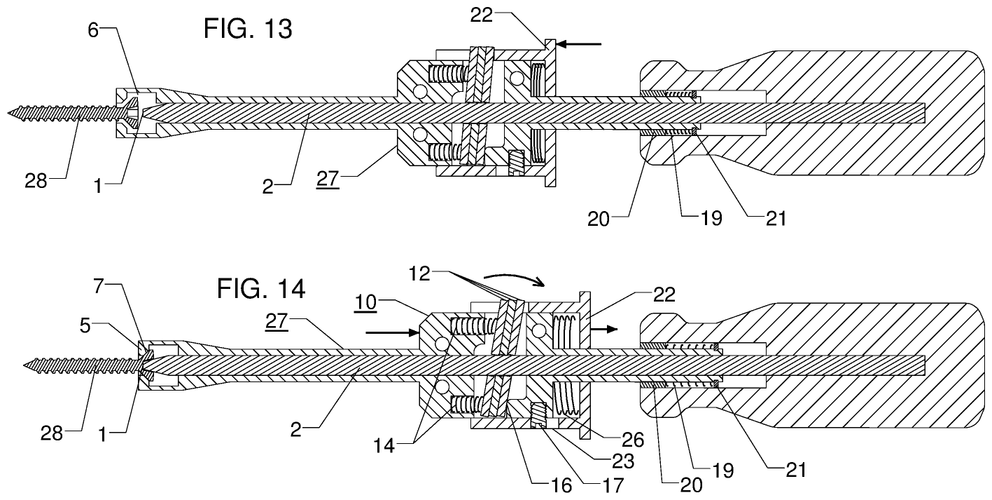

In FIG. 13 the jaw assembly 27 is pushed all the way forward towards the tip 1. The jaw assembly grommet 20, jaw assembly spring 19 and jaw assembly retaining clip 21 act as a stop to limit the motion of the jaw assembly 27 towards the tip 1. The user is maintaining the force on the push ring 22 keeping the jaw assembly 27 in position against the force of the jaw assembly spring 19. The jaw 5 and jaw slot 6 are clear of the shank 2 allowing the user to insert a fastener 28 into the jaw slot 6 so that the head of the fastener 28 is inside of the barrel of the jaw assembly 27 with the threaded end of the fastener 28 pointing out through the slot in the jaw 5 in the same direction as the axis of the jaw carriage hole 35.

In an example, the tip 1 of the fastener holding driver is magnetized. The tip 1 may be constructed of any suitable magnetic material or coated in a magnetic material. The magnetized tip 1 keeps the fastener 28 from falling out of the jaw slot 6. (see also FIGS. 9-10). In FIG. 14 the user relaxes the force on the push ring 22. This causes the push ring 22 to retract from the lock washers 12 in the direction of the handle 3 due to the force of the push ring spring 26. This results in the lock washer springs 14 causing the lock washers 12 to tilt on the lock washer fulcrum 16 causing the lock washers 12 to grip the shank 2 preventing any movement of the jaw assembly 27 towards the tip 1. The relaxing of the force on the push ring 22 also allows the jaw assembly spring 19 to retract the jaw assembly 27 away from the tip 1. The movement of the jaw assembly 27 causes the jaw 5 to move towards the handle 3 contacting the underside of the head of the fastener 28. The concave surface of the jaw fastener guide surface 7 helps to center the fastener 28 as it is pushed up against the tip 1 providing a structure and means on the jaw assembly 27 to guide the fastener 28 onto the tip 1. Since the lock washers 12 prevent any movement of the jaw assembly 27 towards the tip 1 this results in the jaw 5 and jaw assembly 27 rigidly holding the fastener 28 onto the tip 1.

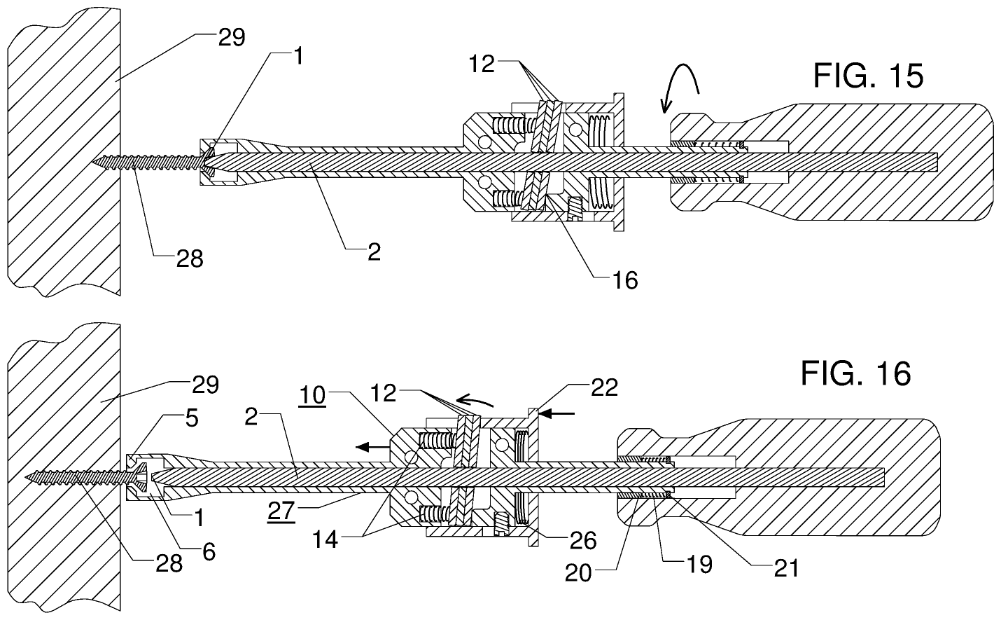

FIG. 15 shows the fastener holding driver inserting the fastener 28 into a work-piece 29. The jaw 5 keeps the fastener 28 rigidly affixed to tip 1 so that the fastener 28 does not slip off.

FIG. 16 shows that the fastener 28 driven most of the way into the work-piece 29. The user exerts force on the push ring 22 this causes the push ring 22 to move towards the lock washers 12. The push ring 22 then contacts the lock washers 12 at the back of the push ring lock washer slot 24 causing the lock washers 12 to tilt and release their grip on the shank 2 allowing the jaw assembly 27 to move towards the tip 1. The force on the push ring 22 pushes the jaw assembly 27 forward in direction toward the tip 1 against the force of the jaw assembly spring 19 until the jaw assembly grommet 20, jaw assembly spring 19 and jaw assembly retaining clip 21 act as a stop. This causes the jaw 5 to move away from the tip 1 allowing the fastener 28 to be removed from the tip 1.

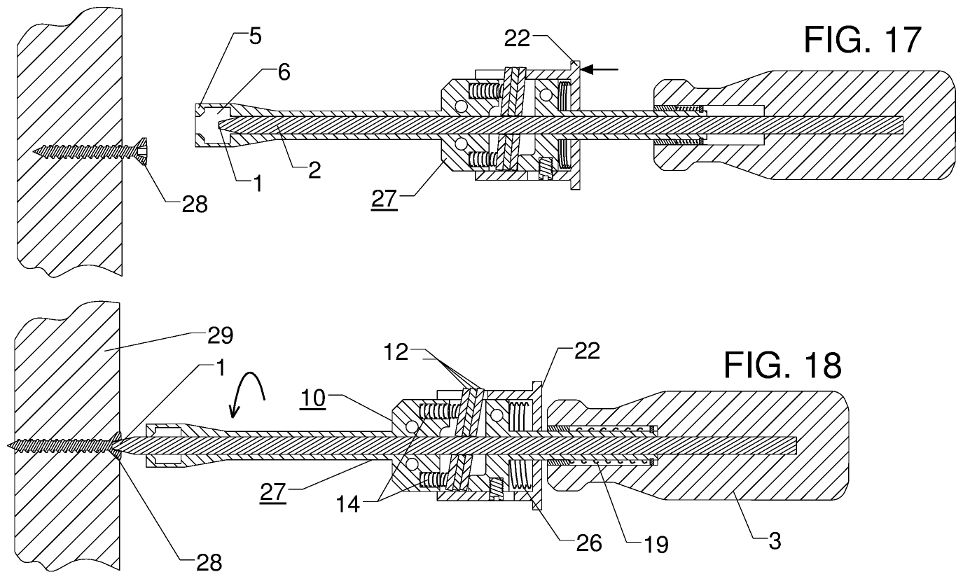

FIG. 17 Shows the user keeping force on the push ring 22 and then removing the fastener 28 from the jaw assembly 27 by moving the fastener holding driver in a direction where the head and thread of the fastener 28 come out through the side of the jaw assembly 27 through the jaw slot 6.

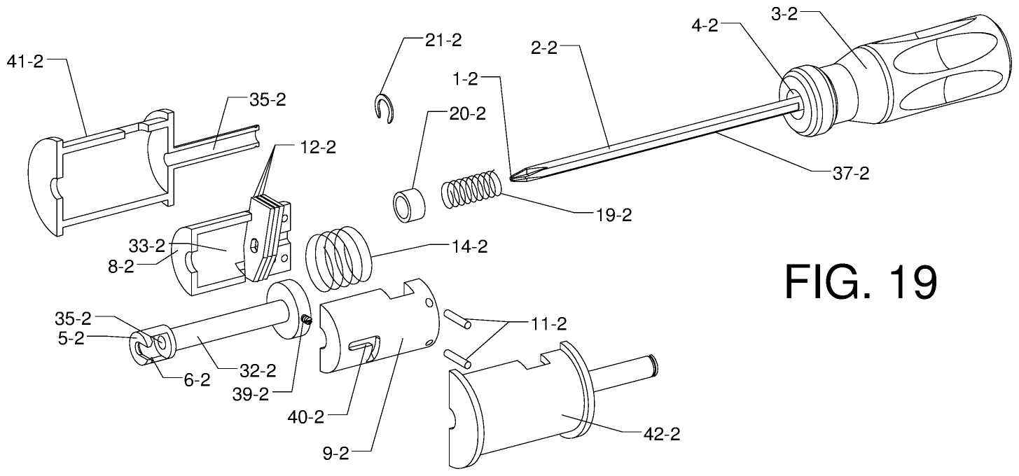

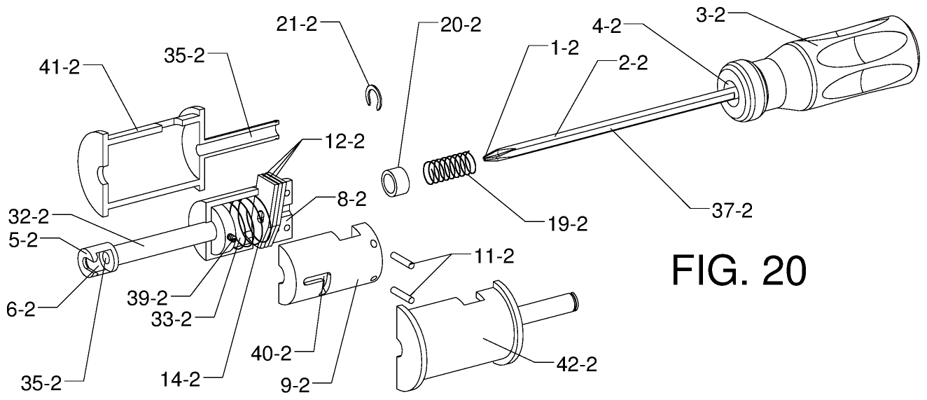

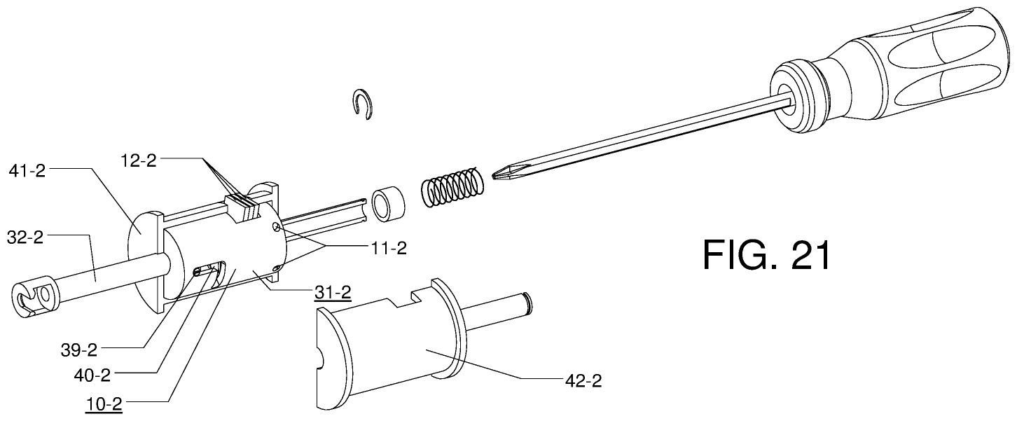

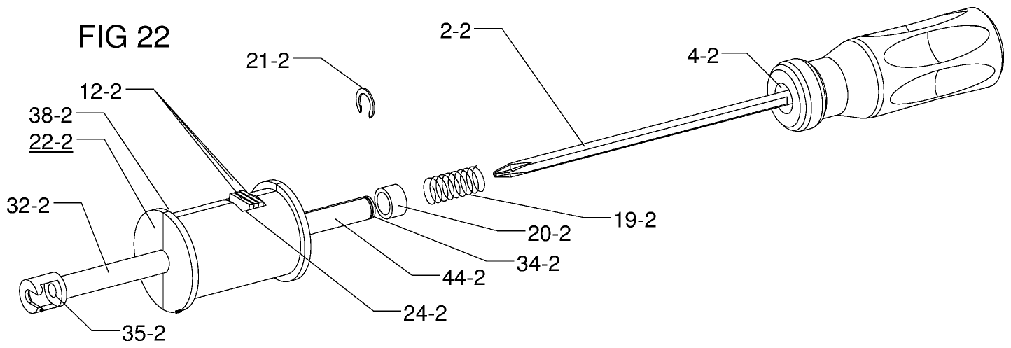

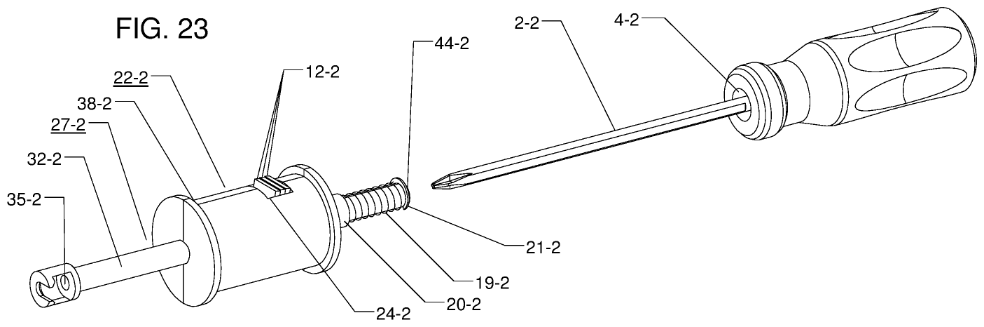

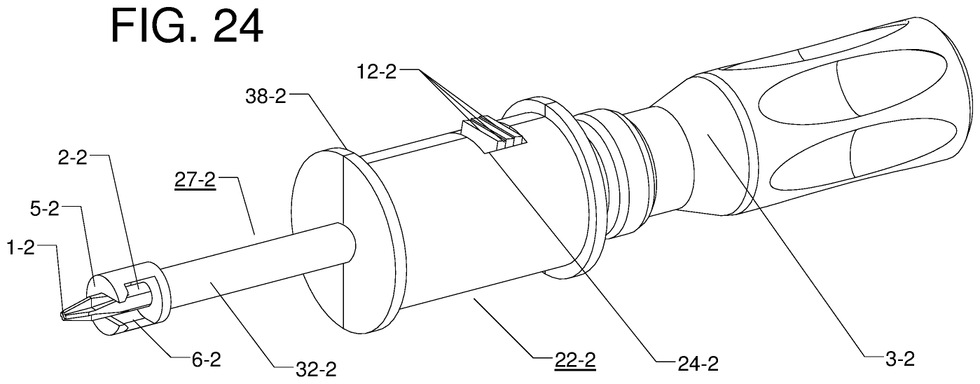

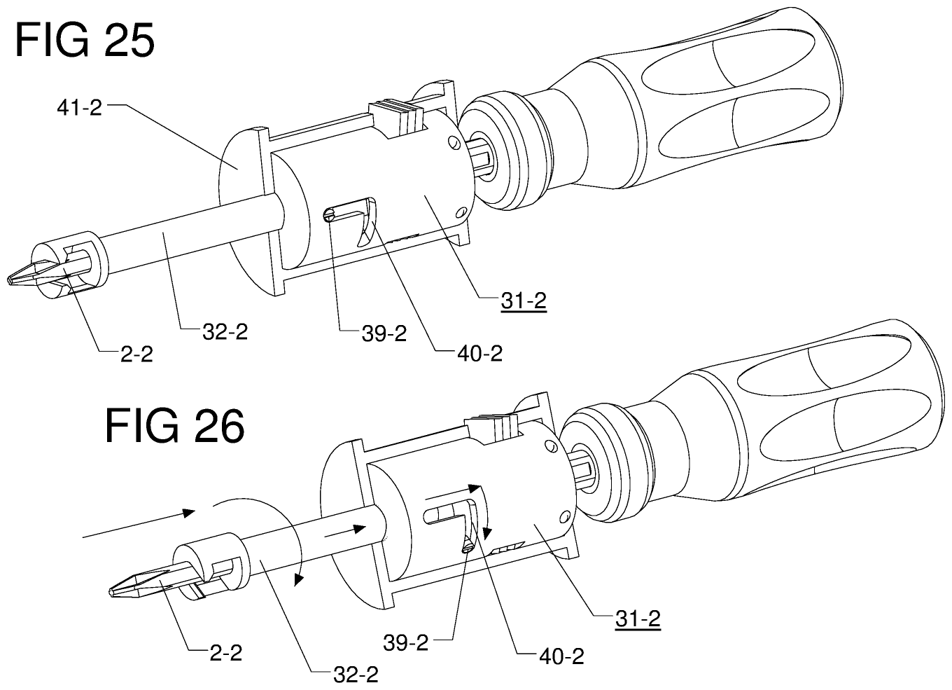

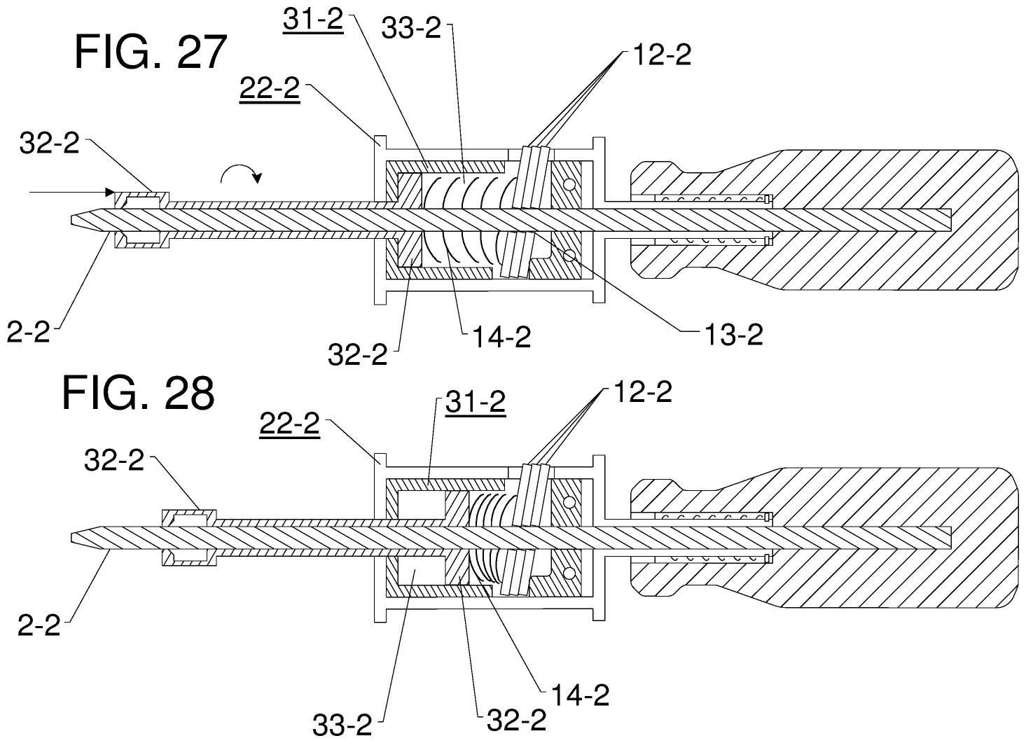

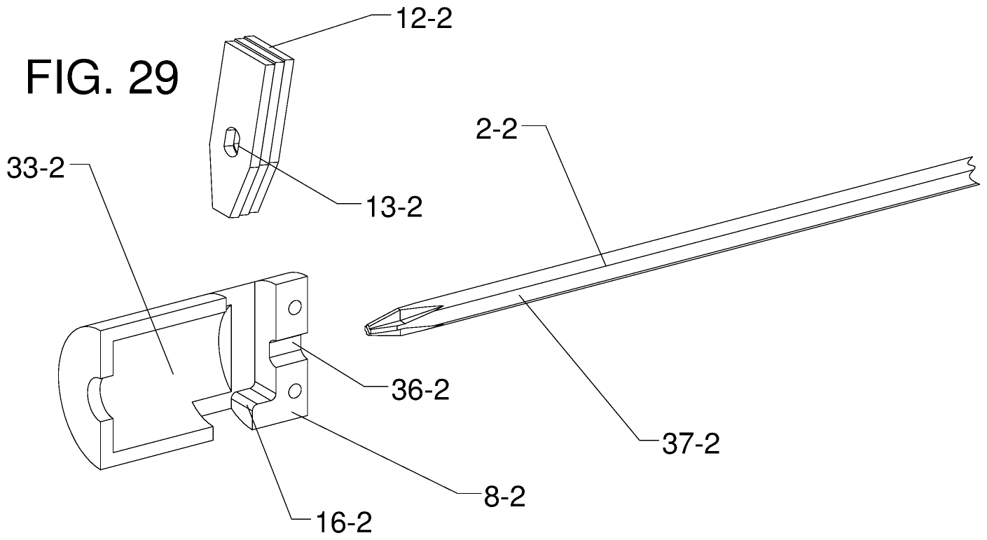

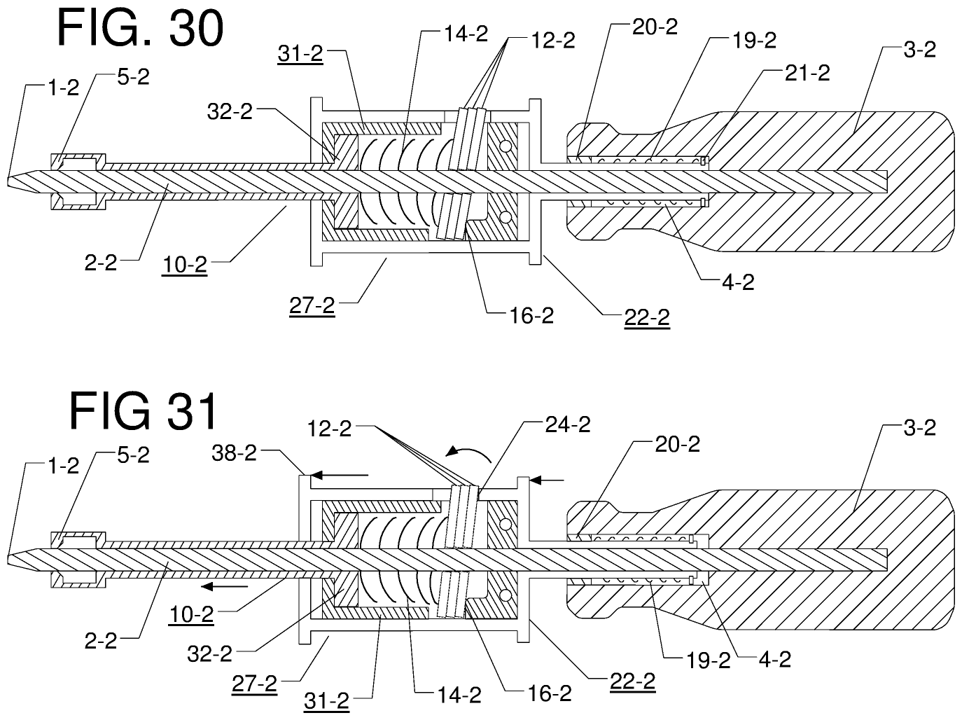

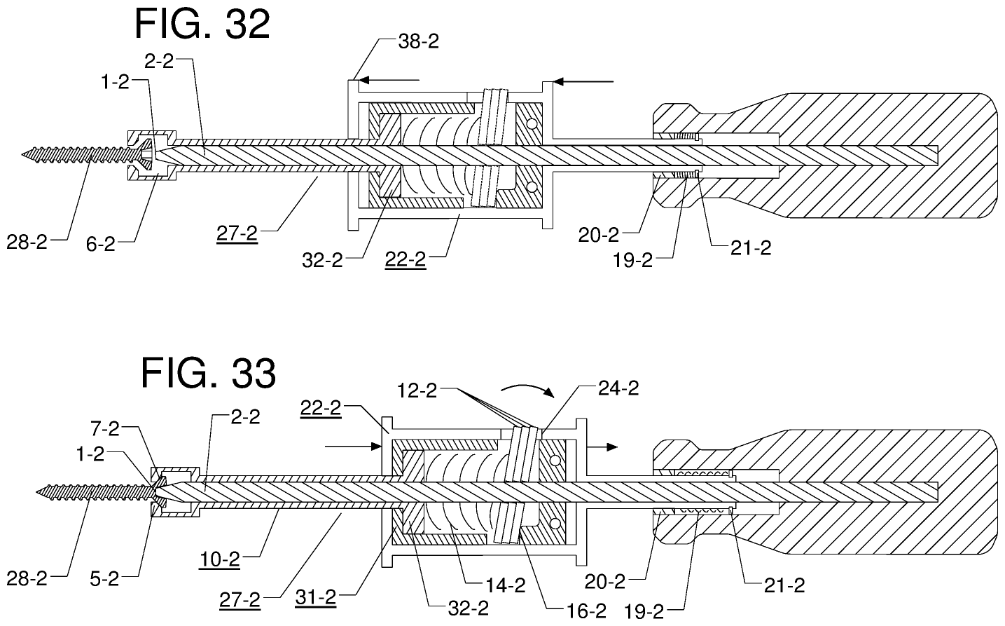

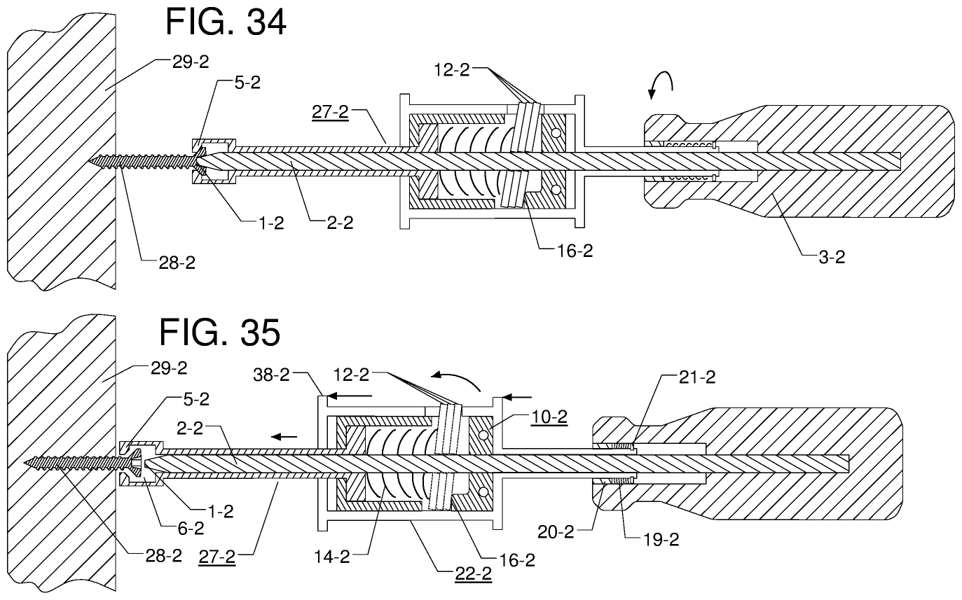

FIG. 18 shows the fastener holding driver after the user relaxes the force on the push ring 22. This causes the push ring 22 to retract from the lock washers 12 in the direction of the handle 3. This results in the lock washer springs 14 causing the lock washers 12 to tilt on the lock washer fulcrum 16 causing the lock washers 12 to grip the shank 2 preventing any movement of the jaw assembly 27 towards the tip 1. The relaxing of the force on the push ring 22 also allows the jaw assembly spring 19 to retract the jaw assembly 27 away from the tip 1 until it is stopped by contact with the bottom of the handle hole 4. In this position the tip 1 of the shank 2 is through the jaw 5 of the jaw assembly 27. This allows the user to use the fastener holding driver in a normal manner and to finish driving the fastener 28 into the work-piece 29.

### DETAILED DESCRIPTION—FIGS. 19 TO 35—SECOND EMBODIMENT

### Detailed Description—Shank 2-2, Tip 1-2, Handle 3-2 and Handle Hole 4-2.

A second embodiment of the fastener holding driver consists of a shank 2-2 with a tip 1-2. The tip 1-2 is magnetized to help temporarily hold a fastener. The other end of the shank 2-2 is inserted into a handle 3-2 with a handle hole 4-2 which is a cylindrical cavity with its axis centered with axis of the shank 2-2 on the side of the handle 3-2 facing the tip 1-2 shown in (FIG. 19). The shank 2-2 has 2 shank flat surfaces 37-2 on both sides which are flat surfaces running the length of the shank 2-2.

In this instance the tip is one used for driving a Phillips head type fastener but any type of tip can be used (Slotted, Torx, Hex socket, etc.). Also instead of having a handle the fastener holding driver could just have a shank which could be inserted as a bit into a drill, screw-gun, or handle for interchangeable bits or have the shank be part of any other device used to drive fasteners such as a ratchet wrench. It should also be noted that other surfaces of the fastener holding driver could be magnetized instead of the tip to help to temporarily hold the fastener in place.

### Detailed Description—Front Jaw Carriage Section 32-2, Rear Jaw Carriage Section 31-2, Jaw Carriage 10-2, Jaw 5-2, Jaw Slot 6-2 and Jaw Fastener Guide Surface 7-2.

In this embodiment there is a jaw carriage 10-2 consisting of a front jaw carriage section 32-2 and a rear jaw carriage lower half 8-2 and a rear jaw carriage upper half 9-2. The front jaw carriage section 32-2 is a cylindrical barrel with a jaw assembly hole 35-2 for the shank 2-2 running down the axis of the barrel with one end having a larger diameter and the opposite end having a jaw 5-2 and jaw slot 6-2. The larger diameter section of the front jaw carriage section 32-2 has a hole with a front jaw carriage section positioning screw 39-2 in it projecting perpendicular to the axis of the jaw assembly hole 35-2. The jaw slot 6-2 is a cylindrical space with the same axis as that of the jaw assembly hole 35-2 and is slightly larger in diameter than the jaw assembly hole 35-2. The jaw slot 6-2 also has an opening in one side of the barrel of the front jaw carriage section 32-2 (FIGS. 19-20). The jaw 5-2 consists of the bottom structure and surface of the cylindrical section of the jaw slot 6-2 which is facing the end of the front jaw carriage section 32-2 with the larger diameter and also has a slot opening in the same direction as that of the opening for the jaw slot 6-2. Additionally the jaw 5-2 has a jaw fastener guide surface 7-2 which is a concave surface formed in the jaw 5 surface facing towards the end of the front jaw carriage section 32-2 with the larger diameter (FIG. 33). The jaw fastener guide surface 7-2 helps guide a fastener into engagement with the tip 1-2 and provides a means and structure to help the user to guide a fastener onto the tip 1-2. The outside diameter of the front jaw carriage section 32-2 with the jaw 5-2 and jaw slot 6-2 is kept as small as possible to allow the driver to insert screws in confined spaces and to facilitate the insertion of the screw into the jaw slot 6-2.

The rear jaw carriage lower half 8-2 and a rear jaw carriage upper half 9-2 are half cylinders that are fastened together with jaw carriage pins 11-2 to form a cylindrical rear jaw carriage section 31-2. The rear jaw carriage section 31-2 has holes in both ends of the long axis. On one end there is a hole for the front jaw carriage section 32-2 along with the shank 2-2 to project through and on the opposite end there is a hole for the shank 2-2 which has two jaw carriage flat engagement surfaces 36-2 on either side. The jaw carriage shank flat engagement surfaces 36-2 mate with the shank flat surfaces 37-2 on the shank 2-2 which allows the jaw carriage 10-2 to slide along the axis of the shaft 2-2 but not to rotate about it, this keeps the rear jaw carriage section 31-2 and the lock washers 12-2 from rotating about the shank 2-2. The rear jaw carriage section 31-2 has a lock washer cavity 33-2 which is a hollow space inside the rear jaw carriage section 31-2 and has openings perpendicular to its long axis opposite of one another. The rear jaw carriage upper half 9-2 has a Front jaw carriage section positioning slot 40-2 which is a “L” shaped lot cut into the outside with one leg in line with the long axis of the rear jaw carriage section 31-2 and the other running partially around its circumference.

In this embodiment there is only one fixed jaw however there could be more than one jaw and the jaws could be fixed or moving with the screw inserted directly into the one or more jaws on the same axis as the shaft. The jaw carriage could also be just one piece or any other combination of equivalent parts. Additionally the fastener guide surface could consist of structures on either the jaw and or tip or both or other independent structures to help guide the fastener into engagement with the tip. The fastener guide surface could also have a much larger concave surface so that fasteners that have heads where the underside is flat also can be seated by contact with the surface. In the case where this embodiment is used with a power tool having the lock washers not rotate around the shank due to torque inertial forces keeps the lock washers from losing their grip and also from them damaging the surface of the shank.

### Detailed Description—Lock Washers 12-2, Lock Washer Spring 14-2, and Front Jaw Carriage Section Positioning Slot 40-2.

Shown in FIGS. 19-21, three lock washers 12-2 are placed into the lock washer cavity 33-2 with the tops of the lock washers 12-2 sticking out of the jaw carriage 10-2 which allows the user to manipulate the lock washers 12-2. The tops of a lock washer 12-2 is defined by the portion of the lock washer 12-2 on the other side of the shank 2-2 from the lock washer fulcrum 16-2. The large diameter of the front jaw carriage section 32-2 is placed inside the lock washer cavity 33-2 so that the end of the front jaw carriage section 32-2 with the jaw 5-2 is sticking out of the rear jaw carriage section 31-2. A

Lock washer spring 14-2 is placed into the lock washer spring cavity 15-2 between the front jaw carriage section 32-2 and the lock washers 12-2. The jaw carriage upper half 9-2 is then assembled to the jaw carriage lower half 8-2 using the jaw carriage pins 11-2 with the front jaw carriage section positioning screw 39-2 projecting through the front jaw carriage section positioning slot 40-2 completing the jaw carriage 10-2. This assembly allows the front jaw carriage section 32-2 to move axially within the rear jaw carriage section 31-2 limited by the movement of the front jaw carriage section positioning screw 39-2 within the front jaw carriage section positioning slot 40-2 allowing the user to adjust the size of the jaw assembly 27-2 by telescoping it to expose more of the tip 1-2 when the jaw assembly 27-2 is not being used. The lock washer spring 14-2 normally keeps the front jaw carriage section 32-2 extended out from the rear jaw carriage section 31-2 as it can go.

It should be noted that having the tops of the lock washers project out of the jaw carriage allows the user to manipulate the lock washers either with an additional element as in this embodiment or alternately by having no element and the user pushing on the tops of the lock washer directly. Additionally not all of the lock washers have to project out of the jaw carriage for this to occur, one or more of the tops of the lock washers could project from the jaw carriage and still allow the user to manipulate all of them. Alternately another spring than the lock washer spring could be used to bias the front jaw carriage section or no spring at all.

### Detailed Description—Jaw Assembly 27-2, Push Ring 22-2, Jaw Assembly Grommet 20-2, Jaw Assembly Spring 19-2 and Jaw Assembly Retaining Clip 21-2.

After the jaw carriage 10-2 is assembled, the push ring upper half 42-2 and push ring lower half 41-2 are welded together over the rear jaw carriage section 31-2 to form a push ring 22-2 which consists of two hollow cylindrical sections where one is larger than the other. The larger section of the push ring 22-2 fits over the rear jaw carriage section 31-2 and allows it to move axially a short distance inside with a hole axially for the front jaw carriage section 32-2 to go through. The push ring 22-2 also has a push ring lock washer slot 24-2 that allows the tops of the lock washers 12-2 to project up through the side of the push ring 22-2. The smaller diameter section of the push ring is the rear push ring section 44-2 which has a jaw assembly hole 35-2 running through its axis for the shank 2-2 projecting out the side opposite of the hole for the front jaw carriage section 32-2. Additionally the push ring 22-2 has a push ring forward engagement surface 38-2 which is a surface on the side of the lock washers 12-2 towards the jaw where the user can use the push ring 22-2 to manipulate the lock washers 12-2 and release the fastener with the same hand that is inserting the fastener into the jaw slot 6-2.

After the push ring 22-2 is installed a jaw assembly grommet 20-2 and then a jaw assembly spring 19-2 are placed over the rear push ring section 44-2 and then a jaw assembly retaining clip 21-2 is placed into the jaw assembly retaining clip groove 34-2 (FIG. 24,25,26).

Collectively the jaw carriage 10-2, lock washers 12-2, lock washer spring 14-2, push ring 22-2, front jaw carriage section positioning screw 39-2, jaw assembly spring 19-2 and jaw assembly retaining clip 21-2 are referred to as the jaw assembly 27-2 in this embodiment (FIG. 3). Further the jaw fastener guide surface 7-2 provides a means and structure on the jaw assembly 27-2 to help the user to guide a fastener onto the tip 1-2.

The body of the jaw carriage 10-2 and the push ring 22-2 have a larger diameter than the front jaw carriage section 32-2 of the jaw assembly 27-2 that extends to the jaw 5-2. The body of the jaw carriage 10-2 and the push ring 22-2 have a larger diameter than the jaw 5-2. When the jaw 5-2 and the front jaw carriage section 32-2 of the jaw assembly 27-2 are smaller than the rear jaw carriage section 31-2, a user is able to drive a fastener into structures in which a typical fastener driving device would not fit. For example, the smaller jaw 5-2 and jaw assembly 27-2 would be insertable into a hole that is only incrementally larger than the fastener itself. Further, the fastener holding driver is easier to manipulate with the smaller jaw 5-2. The smaller jaw 5-2 and jaw assembly 27-2 also make the fastener holding driver lighter and easier to use with a single hand.

It should be noted that section of the jaw carriage 10-2 containing the lock washers 12-2 has a larger outside diameter than the front jaw carriage section 32-2 having the jaw 5-2 and jaw slot 6-2. This allows the lock washer fulcrum 16-2 to be far enough from the centerline of the shank 2-2 that sufficient tilting force (torque) is put on the lock washers 12-2. This causes the lock washers 12-2 to grip the shank 2-2 with adequate force to keep a screw firmly attached to the tip 1-2. This size difference also allows the front jaw carriage section 32-2 having the jaw 5-2 and jaw slot 6-2 to be small enough to fit into confined spaces to insert a screw. Thus having the lock washer fulcrum 16-2 farther away from the centerline of the shank 2-2 than the end outside diameter of the front jaw carriage section 32-2 containing the jaw 5-2 and jaw slot 6-2 allows the lock washers 12-2 to grip the shank 2-2 with sufficient force while also keeping the end of the front jaw carriage section 32-2 containing the jaw 5-2 and jaw slot 6-2 small enough to fit into confined spaces. It should also be noted that the push ring forward engagement surface 38-2 could extend further towards the jaw 5-2 depending on the ergonomic preference of the design.

### Detailed Description—Final Assembly, Lock Washer Fulcrum 16-2, Lock Washer Holes 13-2.

The shank 2-2 is inserted through the jaw assembly hole 35-2 at the rear push ring section 44-2, into the rear jaw carriage section 31-2 and then through lock washer holes 13-2 which are holes in the three lock washers 12-2 that are slightly larger in diameter than the shank 2-2. The shank 2-2 is inserted further through the front jaw carriage section 32-2 and out through the jaw 5-2. (FIGS. 24,24,27). The jaw assembly grommet 20-2 is affixed to the entrance handle hole 4-2 so that the part of the rear push ring section 44-2 with the jaw assembly spring 19-2 and jaw assembly retaining clip 21-2 is confined inside the handle hole 4-2. The force of the jaw assembly spring 19-2 against the jaw assembly grommet 20-2 and the jaw assembly retaining clip 21-2 cause the jaw assembly 27-2 to be normally pushed back towards the handle 3-2 until the jaw assembly 27-2 contacts the bottom of the handle hole 4-2 retracting the jaw assembly 27-2 away from the tip 1-2 so that the tip 1-2 is exposed (FIG. 30). This allows the jaw assembly spring 19-2 to bias the jaw assembly 27-2 in a direction on the shank 2-2. The jaw assembly spring 19-2 further acts as an element and means to normally keep the push ring 22-2 from contacting the lock washers 12-2.

Also the jaw assembly grommet 20-2, jaw assembly spring 19-2 and the jaw assembly retaining clip 21 act collectively as a stop to limit the motion of the jaw assembly 27-2 towards the tip 1-2 of the shank 2-2.

Further the lock washer spring 14-2 push the lock washers 12-2 against the lock washer fulcrum 16-2 which is a structure located below the jaw assembly hole 35-2. This causes the lock washers 12-2 to tilt and to grip the shank 2-2 with the lock washer holes 13-2. In this situation any force that causes the jaw assembly 27-2 to move away from the tip 1-2 causes the tilt of lock washers 12-2 to lessen and to allow movement in that direction. However any movement of the jaw assembly 27-2 in the direction towards the tip 1-2 causes the lock washer fulcrum 16-2 to contact the lock washers 12-2 with increased force thus increasing their tendency to tilt and increasing the force of the grip of the lock washers 12-2 on the shank 2-2 by the lock washer holes 13-2 preventing movement in that direction (FIG FIGS34-35). Additionally in order to aid the gripping force of the lock washers 12-2 on the shank 2-2 the hardness of the material of the lock washers 12-2 is harder than the material of the shank 2-2.

It should be noted that alternatively the jaw assembly spring could be used to bias the jaw assembly in the other direction or a jaw assembly spring might not be used at all. Also any other type of structure on the shank or jaw assembly could alternately be used for the purpose of a stop limiting the motion of the jaw assembly towards the tip of the shank. The push ring could also be a different structure or types of structures and could move in a variety of different ways. Additionally a stop to limit the movement of the jaw assembly movement away from the tip, such as in the case of a bit without a handle can also be included. Alternatively the material of the shank and lock washers could also be equal in hardness or the shank material could be harder than that of the lock washers depending on what characteristics are required.

The fastener holding driver includes a mechanical stop to prevent the jaw assembly 27-2 from being removed completely from the shank 2-2. In an example, the jaw assembly 27-2 and the shank 2-2 are parts of a single assembly that is constructed to be used as a single tool. That is, the jaw assembly 27-2 in the example is not an attachment to an existing tool.

By preventing the fastener holding driver from being removed from the shank 2-2, the two pieces of the fastener holding driver remain together and are not potentially lost or misplaced. Further, the mechanical stop will provide an additional benefit in that the stop will allow the jaw 5-2 to be extended past the tip 1-2 a preferred distance to insert a fastener. That is, the jaw 5-2 will extend past the tip 1-2 a distance that allows a fastener to be inserted into the jaw slot 6-2, but not so far past the tip 1-2 that the jaw assembly 27-2 is in danger of disengaging from the shank 2-2 or becoming insecure.

Also it should be noted that in this specification holding the jaw rigidly is used interchangeably with holding the jaw with large force. This can also mean holding the jaw against great force.

### OPERATION—FIGS. 25-28 AND FIGS. 30 TO 35—2nd EMBODIMENT

FIGS. 25-28 show views of the operation of the telescoping feature of the second embodiment.

FIGS. 25 and 27 show the 2^{nd} embodiment of the fastener retaining driver in normal position with the lock washer spring 14-2 pushing out the front jaw carriage section 32-2 towards the tip 1-2 as far as possible. The user grasps the front jaw carriage section 32-2 with one hand and pushes it directly into the rear jaw carriage section 31-2 against the force of the lock washer spring 14-2 until the front jaw carriage positioning screw reaches the corner of the front jaw carriage section positioning slot 40-2. At this point the user rotates the front jaw carriage section 32-2 around the axis of the shank 2-2 so that the front jaw carriage section positioning screw 39-2 enters the portion of the front jaw carriage section positioning slot 40-2 that is cut axially to the shank 2-2 (FIGS. 26, 28). In this position the front jaw carriage section positioning slot 40-2 keeps the front jaw carriage section 32-2 in place against the force of the lock washer spring 14-2 with more of the shank 2-2 exposed for use in confined spaces. In order to return the fastener retaining driver back to its original position for normal operation the user simply reverses the process. Thus the user can change the length of the jaw assembly 27-2 to expose more of the shank 2-2.

FIGS. 30 through 35 shows sectional views of the 2^{nd} embodiment of the fastener holding driver in operation.

FIG. 30 shows the fastener holding driver with the jaw assembly 27-2 in the position of being normally retracted away from the tip 1-2 by the jaw assembly spring 19-2 which also acts to keep the push ring 22-2 away from the lock washers 12-2. The lock washers 12-2 are in the position of being normally pushed against the lock washer fulcrum 16-2 by the lock washer spring 14-2, causing the lock washers 12-2 to grip the shank 2-2 and to prevent any movement of the jaw assembly 27-2 towards the tip 1-2.

In FIG. 31 a force is generated by the user on the push ring 22-2 towards the tip 1-2. This results in a force on the jaw assembly 27-2 towards the tip 1-2. This force also causes the push ring 22-2 to contact the lock washers 12-2 at the back of the push ring lock washer slot 24-2 causing the lock washers 12-2 to tilt forward against the force of the lock washer spring 14-2. This causes the jaw assembly 27-2 to move forward towards the tip 1-2 against the force of the jaw assembly spring 19-2.

In FIG. 32 the jaw assembly 27-2 is pushed all the way forward towards the tip 1-2. The jaw assembly grommet 20-2, jaw assembly spring 19-2 and jaw assembly retaining clip 21-2 act as a stop to limit the motion of the jaw assembly 27-2 towards the tip 1-2. The user is maintaining the force on the push ring 22-2 keeping the jaw assembly 27-2 in position against the force of the jaw assembly spring 19-2. The jaw 5-2 and jaw slot 6-2 are clear of the shank 2-2 allowing the user to insert a fastener 28-2 into the jaw slot 6-2 so that the head of the fastener 28-2 is inside of the barrel of the jaw assembly 27-2 with the threaded end of the fastener 28-2 pointing out through the slot in the jaw 5-2 in the same direction as the axis of the jaw assembly hole 35-2.

In an example, the tip 1-2 of the fastener holding driver is magnetized. The tip 1-2 may be constructed of any suitable magnetic material or coated in a magnetic material. The magnetized tip 1-2 keeps the fastener 28-2 from falling out of the jaw slot 6-2.

In FIG. 33 the user relaxes the force on the push ring 22-2. This causes the push ring 22-2 to retract from the lock washers 12-2 in the direction of the handle 3-2 due to the force of the jaw assembly spring 19-2. This results in the lock washer spring 14-2 causing the lock washers 12-2 to tilt on the lock washer fulcrum 16-2 causing the lock washers 12-2 to grip the shank 2-2 preventing any movement of the jaw assembly 27-2 towards the tip 1-2. The relaxing of the force on the push ring 22-2 also allows the jaw assembly spring 19-2 to retract the jaw assembly 27-2 away from the tip 1-2. The movement of the jaw assembly 27-2 causes the jaw 5-2 to move towards the handle 3-2 contacting the underside of the head of the fastener 28-2. The concave surface of the jaw fastener guide surface 7-2 helps to center the fastener 28-2 as it is pushed up against the tip 1-2 providing a structure and means on the jaw assembly 27-2 to guide the fastener 28-2 onto the tip 1-2. Since the lock washers 12-2 prevent any movement of the jaw assembly 27-2 towards the tip 1-2 this results in the jaw 5-2 and jaw assembly 27-2 rigidly holding the fastener 28-2 onto the tip 1-2.

FIG. 34 shows the fastener holding driver inserting the fastener 28-2 into a work-piece 29-2. The jaw 5-2 keeps the fastener 28-2 rigidly affixed to tip 1-2 so that the fastener 28-2 does not slip off.

FIG. 35 shows that the fastener 28-2 driven most of the way into the work-piece 29-2. The user exerts force on the push ring 22-2 this causes the push ring 22-2 to move towards the lock washers 12-2. The push ring 22-2 then contacts the lock washers 12-2 at the back of the push ring lock washer slot 24-2 causing the lock washers 12-2 to tilt and release their grip on the shank 2-2 allowing the jaw assembly 27-2 to move towards the tip 1-2. The force on the push ring 22-2 pushes the jaw assembly 27-2 forward in direction toward the tip 1-2 against the force of the jaw assembly spring 19-2 until the jaw assembly grommet 20-2, jaw assembly spring 19-2 and jaw assembly retaining clip 21-2 act as a stop. This causes the jaw 5-2 to move away from the tip 1-2 allowing the fastener 28-2 to be removed from the tip 1-2. The user then allows the jaw assembly spring 19-2 to retract the jaw assembly 27-2 away from the tip 1-2 so that the user can use the tip 1-2 to drive the fastener 28-2 all the way in.

### Conclusions Ramifications and Scope

Accordingly the reader can see that the fastener holding driver allows the user to easily insert and remove fasteners using just one hand, where the fastener is held onto the tip with a large amount of force. Also that the jaw to hold the fastener retracts conveniently out of the way by the force of a spring so that the fastener holding driver can be used in a normal manner. The fastener holding driver also aids the user in seating the fastener onto the tip by use of a guide surface as well as keeping the fastener from falling out of the slot by use of a magnetized surface. The fastener holding driver can telescope to expose more of the shank for tight spaces and has a surface for releasing the lock washers on the tip side of the lock washers which aids in ergonomics. In addition the fastener holding driver does not allow the lock washers to rotate about the shank which would affect their gripping strength with power tool applications.

Although the description above contains many specificities, these should not be construed as limiting the scope of the embodiments.

Any type of tip could be used (Slotted, Torx, Hex socket, etc.) in this application. Also instead of having a handle the fastener holding driver could just have a shank which could be inserted as a bit into a drill, screw-gun, or handle for interchangeable bits or have the shank be part of any other device used to drive fasteners such as a ratchet wrench. In an example, the tip of the shank, or the shank itself is interchangeable to accommodate fasteners with alternative engagement configurations. For example, the tip, or the entire shank may be interchanged with a slotted engagement, hexagonal socket engagement, Torx engagement, or any other suitable engagement tip.

Other surfaces of the fastener holding driver could be magnetized instead of the tip to help to temporarily hold the fastener in place.

The jaw assembly can come in a variety of shapes with multiple moving parts and could have more than one jaw and the jaws could be fixed or moving with the screw inserted directly into the one or more jaws on the same axis as the shaft. Additionally the fastener guide surface could consist of structures on either the jaw and or tip or both or other independent structures to help guide the fastener into engagement with the tip. The fastener guide surface could also have a much larger concave surface so that fasteners that have heads where the underside is flat also can be seated by contact with the surface.

Any number of lock washers and lock washer springs could be used in a variety of configurations in conjunction with one or more jaw spring cavities which would provide structures and means for locating lock washer springs.

The jaw assembly spring could be used to bias the jaw assembly in the other direction or a jaw assembly spring might not be used at all. Also any other type of structure on the shank or jaw assembly could alternately be used for the purpose of a stop limiting the motion of the jaw assembly towards the tip of the shank. Also a stop to limit the jaw assembly movement away from the tip can also be used or not used. The push ring could also be a different structure or types of structures and could move in a variety of different ways. A separate push ring spring or the jaw assembly spring also can be used to keep the push ring from normally contacting the lock washers if so desired.

Thus the scope of the embodiments should be determined by the appended claims and their legal equivalents, rather than by the examples given.

What is claimed is:

1. A fastener holding driver consisting of:
a shank with a tip for engaging a fastener;
a Jaw assembly on said shank consisting of:
one or more jaws;
one or more lock washers, said one or more lock washers engaging said shank; and
one or more lock washer springs, said one or more lock washer springs cause said one or more lock washers to be engaged with said shank; and
one or more stops to limit the motion of said jaw assembly on said shank;
wherein said jaw assembly holds a fastener rigidly on said tip.

2. The fastener holding driver of claim 1, wherein said one or more stops prevents said jaw assembly from being removed from said shank.

3. The fastener holding driver of claim 1, wherein the length of said jaw assembly can be changed to expose more of said shank.

4. The fastener holding driver of claim 1, wherein said lock washers do not rotate around said shank.

5. The fastener holding driver of claim 1 further having an element for manipulating said one or more lock washers and further having a spring to normally keep said element from contacting said one or more lock washers.

6. The fastener holding driver of claim 5 where part of said element extends into the side of said one or more lock washers that is towards said one or more jaws.

7. A fastener holding driver consisting of:
a shank with a tip for engaging a fastener;
a Jaw assembly on said shank consisting of:
one or more jaws;
one or more lock washers, said one or more lock washers engaging said shank; and
one or more lock washer springs, said one or more lock washer springs cause said one or more lock washers to be engaged with said shank; and
a Jaw assembly spring for biasing said Jaw assembly in a direction on said shank;
wherein said jaw assembly holds a fastener rigidly on said tip.

8. The fastener holding driver of claim 7, wherein said jaw assembly spring biases said jaw assembly away from said tip.

9. The fastener holding driver of claim 7 wherein the length of said jaw assembly can be changed to expose more of said shank.

10. The fastener holding driver of claim 7, wherein said lock washers do not rotate around said shank.

11. The fastener holding driver of claim 7, further having a magnetized surface for temporarily holding said fastener.

12. The fastener holding driver of claim 7, wherein there is a structure on said jaw assembly to help the user to guide a fastener onto said tip.

13. The fastener holding driver of claim 7 further having an element for manipulating said one or more lock washers and further having a spring to normally keep said element from contacting said one or more lock washers.

14. The fastener holding driver of claim 13 where part of said element extends into the side of said one or more lock washers that is towards said one or more jaws.

15. A fastener holding driver consisting of:
a shank with a tip for engaging a fastener;
a Jaw assembly on said shank consisting of:
one or more jaws;
one or more lock washers, said one or more lock washers engaging said shank; and
one or more lock washer springs, said one or more lock washer springs causing said one or more lock washers to be engaged with said shank; and
a lock washer fulcrum;
wherein said lock washer fulcrum is further out from the center line of said shank than the outer end diameter of said jaw;
wherein said jaw assembly holds a fastener rigidly on said tip.

16. The fastener holding driver of claim 15 wherein the length of said jaw assembly can be changed to expose more of said shank.

17. The fastener holding driver of claim 15, wherein said lock washers do not rotate around said shank.

18. The fastener holding driver of claim 15, further having a magnetized surface for temporarily holding said fastener.

19. The fastener holding driver of claim 15 further having an element for manipulating said one or more lock washers and further having a spring to normally keep said element from contacting said one or more lock washers.

20. The fastener holding driver of claim 19 where part of said element extends into the side of said one or more lock washers that is towards said one or more jaws.
